(19) United States
(12) Patent Application Publication
(10) Pub. No.: US 2013/0238395 A1
(43) Pub. Date: Sep. 12, 2013

(54) Composite Driver Derivation

(71) Applicant: Jerry Z. Shan, Palo Alto, CA (US)

(72) Inventor: Jerry Z. Shan, Palo Alto, CA (US)

(21) Appl. No.: 13/883,498

(22) PCT Filed: Nov. 27, 2010
(86) PCT No.: PCT/US10/58141

§ 371 Date: May 3, 2013

(51) Int. Cl. G06Q 30/02

(52) U.S. Cl. CPC G06Q 30/0202
USPC 705/7.31

(57) ABSTRACT

A crossover point between a first driver and a second driver over a series of time points is identified. Each of the first driver and the second driver is a variable, and affects or relates to revenue to be forecast. A composite driver from the first driver and the second driver is derived based on the revenue, using a model having one or more first weighting parameters for the time points before the crossover point and one or more second weighting parameters for the time points after the crossover point. The crossover point is a time point within the series of time points at which the revenue transitions from being more affected by the first driver than by the second driver to being more affected by the second driver than by the first driver.

### BACKGROUND

A business entity like a corporation focuses on revenue as a barometer as to how well the business entity is performing. Gross revenue is the income that a business entity receives from its normal business activities, such as the sale of goods and services. Net revenue can be the gross revenue minus the expenses that the business entity incurred in performing its normal business activities, including salaries, capital expenses, and potentially taxes.

### BRIEF DESCRIPTION OF THE DRAWINGS

FIGS. 1A and 1B are flowcharts of a method for deriving and using a composite driver from a first driver and a second driver, according to an example of the disclosure.

FIG. 2 is a graph of revenue and two example drivers after normalization, according to an example of the disclosure.

FIG. 3 is a graph depicting a relative strength of one example driver of FIG. 2.

FIG. 4 is a graph depicting results of a cumulative sum change-point detection technique applied to the relative strength of FIG. 3.

FIG. 5 is a graph of revenue and a composite driver derived from the two example drivers of FIG. 2, according to example of the disclosure.

FIG. 6 is a diagram of a system, according to an example of the disclosure.

### DETAILED DESCRIPTION

As noted in the background section, a business entity focuses on revenue as a barometer as to how well the business entity is performing. It can be desirable for the business entity to forecast revenue, such as gross revenue or net revenue. One approach for forecasting revenue involves using a model that is constructed using drivers. A driver is a variable that affects or relates to the revenue to be forecast.

However, some drivers are related to one another, which may not be able to be easily taken into account when constructing the model. For instance, before a given point in time, a first driver may influence revenue more than a second driver influences the revenue. By comparison, after this given point in time, the second driver may influence the revenue more than the first driver does. This point in time is referred to herein as a crossover point.

Disclosed herein are approaches for deriving a composite driver from at least a first driver and a second driver having at least one crossover point. Generally, the crossover point is identified. The composite driver is then derived from the first driver and the second driver, based on the revenue, and using a dynamic mixture model.

The model has one or more first weighting parameters for the time points before a crossover point, and one or more second weighting parameters for the time points after the crossover point. For instance, the first weighting parameter(s) can control the weight of each of the first and second drivers within the composite driver before the crossover point. By comparison, the second weighting parameter(s) can control the weight of each of the first and second drivers within the composite driver after the crossover point.

Therefore, when the model for forecasting revenue is constructed, the composite driver is used in lieu of the first and second drivers. As such, the model may more accurately forecast revenue, because the model inherently takes into account the interrelatedness between the first and second drivers. This is due to the model being constructed using the composite driver, which is derived by at least implicitly taking into account the interrelatedness between the first and second drivers.

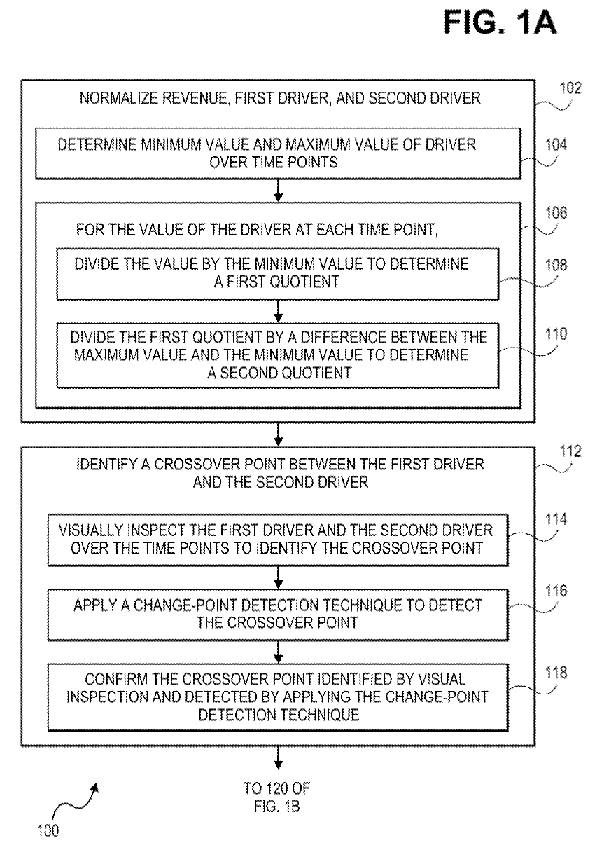

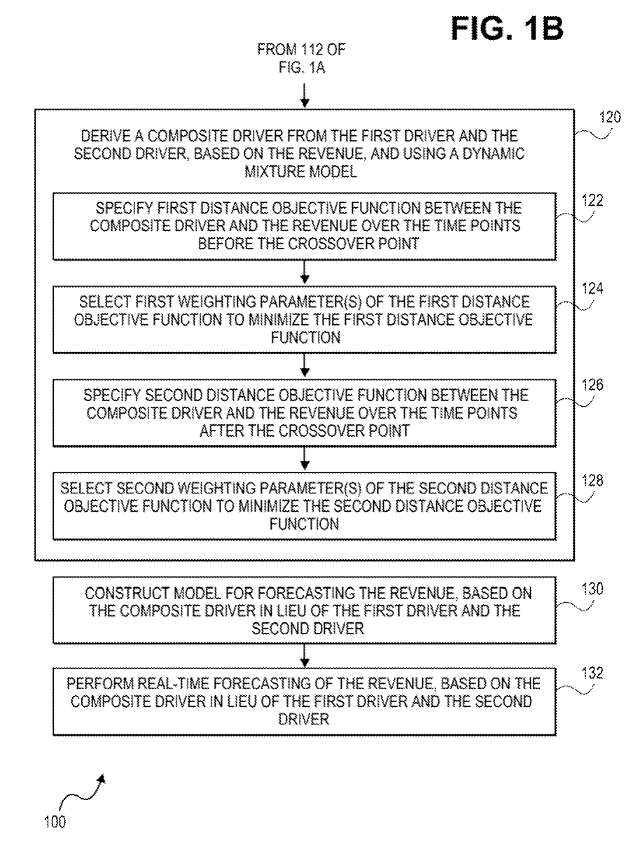

More specifically, FIGS. 1A and 1B show a method 100 for deriving and using a composite driver from a first driver and a second driver, according to an example of the disclosure. At least some parts of the method 100 can be performed by a processor, such as a processor of a computing device like a desktop computer or a laptop computer. For instance, at least some parts of the method 100 may be implemented as a computer program stored on a non-transitory computer-readable data storage medium. Execution of the computer program by the processor thus results in performance of these parts of the method 100.

A driver is generally a variable that has a value for each of a series of time points. For these same time points, the revenue is also known. A driver may have a direct causal effect relationship to the revenue, or each driver may be conceptually correlated to revenue on a lagging or leading basis, either negatively or positively. A driver may be specific to the business entity. For example, a business entity may use a unit of production to generate the product that it sells. There may be different types of such units of production. The number of each type of unit of production may be considered a driver.

A driver may alternatively be specific to the industry in which the business entity operates. For example, the number of products sold by all the business entities within the industry may be a driver. A driver may alternatively be a national-wide driver or an international-wide driver. For example, a national-wide driver may be the gross domestic product of a country in which the business entity operates. As another example, an international-wide driver may be the percentage increase or decreases in growth of the global economy.

As a particular example of the first driver and the second driver in relation to which the method 100 is performed, the first driver may be the number of a first type of unit of production to generate products that a business entity sells. The second driver may be the number of a second type of unit of production to generate these products. Over time, the business entity may be transitioning from the first type of unit of production to the second type of unit of production. As such, before a crossover point, the first driver influences revenue more than the second driver does, and after the crossover point, the second driver influences the revenue more than the first driver does.

Referring to FIG. 1A, the first driver, the second driver, and the revenue can each be normalized (102). Each of the first driver, the second driver, and the revenue has a value along a y-axis for a series of time points along an x-axis. However, the first and second drivers and the revenue may have different scales along their y-axes. As such, the first and second drivers and the revenue can be normalized to the same scale so that they can be directly compared. The first and second drivers and the revenue can be normalized as follows, where the description is particularly made in relation to a given driver as representative of the revenue and the first and second drivers.

The minimum value and the maximum value of the driver along the y-axis over the time points along the x-axis are determined (104). For the value of the driver along the y-axis at each time point along the x-axis, the following is performed (106). The value at the time point in question is divided by the minimum value to determine a first quotient (108). The first quotient is divided by the difference between the maximum value and the minimum value of the driver to determine a second quotient (108). The second quotient is thus the normalized value for the driver at the time point in question.

An approach that is different than that described in relation to parts 104-110 may be used to normalize the first driver, the second driver, and the revenue. For instance, in relation to a given driver as representative of the first and second drivers and the revenue, another normalization technique determines an overall mean and a standard deviation of the driver of the series of time points. The value of the driver at each time point is subtracted from the overall mean, and the resulting difference divided by the standard deviation to determine the normalized value for the driver at each time point.

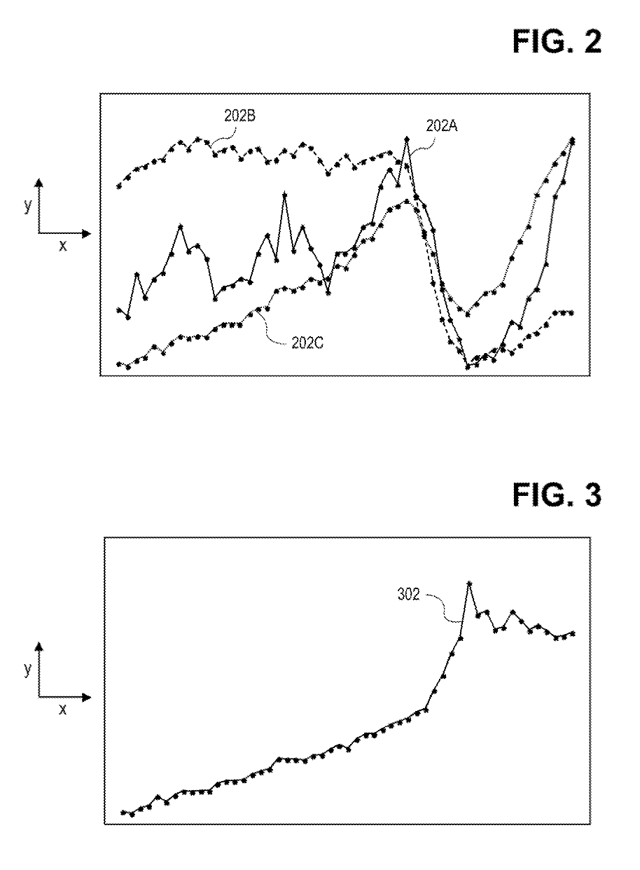

FIG. 2 is a graph of example revenue, an example first driver, and an example second driver after normalization. The line 202A corresponds to the revenue. The lines 202B and 202C correspond to the first driver and the second driver, respectively. The y-axis of FIG. 2 for the revenue and each driver denotes normalized values. The x-axis of FIG. 2 denotes a series of time points.

Referring back to FIG. 1A, a crossover point between the first driver and the second driver is identified (112). The crossover point is a time point within the series of time points at which the revenue transitions from being more influenced by the first driver than by the second driver to being more influenced by the second driver than by the first driver. The crossover point can be identified as follows.

The first driver and the second driver over the series of time points can be visually inspected by a first user to identify the crossover point (114). For instance, in FIG. 2, it can be seen that in the first two-thirds or three-quarters of the graph that the revenue denoted by the line 202A more closely tracks the first driver denoted by the line 202B, and that in the last third or last quarter of the graph that the revenue more closely tracks the second driver denoted by the line 202C. As such, the first user may identify the crossover point as a time point around the two-thirds to three-quarters mark of the graph along the x-axis. The first user may be a statistician or a user who is constructing or is assisting in the construction a model to forecast revenue.

A change-point detection technique can be applied to detect the crossover point as well (116). An example of a change-point detection technique is a cumulative sum change-point detection technique. To apply a change-point detection technique, the percentage of the first driver over the sum of the first driver and the second driver at each time point is determined to acquire the relative strength of the first driver over the series of time points. Thereafter, a change-point detection technique, such as the cumulative sum change-point detection technique, is applied to detect the crossover point.

FIG. 3 is a graph depicting the relative strength of the example first driver of FIG. 2B over the series of time points. The line 302 denotes the relative strength of the example first driver, and has a value over a y-axis for each time point over an x-axis. The y-axis denotes the percentage of the first driver over the sum of the first driver and the second driver, and the x-axis denotes the series of time points.

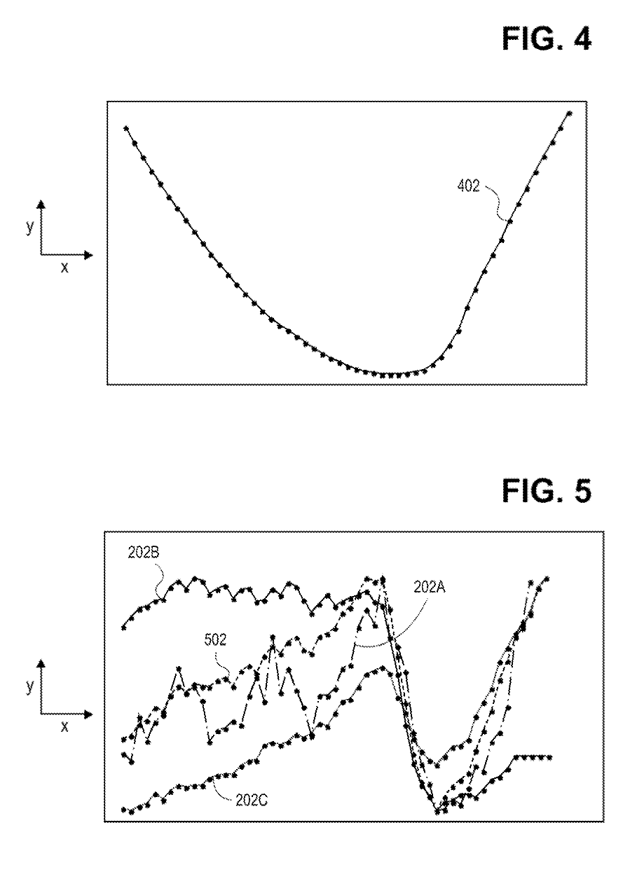

FIG. 4 is a graph depicting the results of a cumulative sum change-point detection technique applied to the relative strength of the example first driver of FIG. 2B as depicted in FIG. 3. The line 402 denotes the cumulative sum of the residual time series, which is the difference between the line 302 of FIG. 3 and an average of the values represented by the line 302. The y-axis denotes a strength of centered cumulative values resulting from application of the cumulative sum change-point detection technique, whereas the x-axis denotes the series of time points. In FIG. 4, the crossover point occurs and is detected at the time point at which the line 402 is at a minimum along the y-axis.

Referring back to FIG. 1A, the crossover point detected in part 116 can be compared to the crossover point identified by the first user in part 114 to determine whether they are roughly aligned with one another. If so, the crossover point is confirmed by a second user (118). For instance, the second user may be an individual who is employed by the business entity for which a model for generating revenue is to be constructed, or who otherwise has knowledge of the operations of the business entity. The second user can thus confirm that the crossover point that has been identified and detected represents a real structural change in transitioning from the first driver to the second driver, as opposed to a statistical anomaly.

It is noted that the crossover point identified in part 114 may be a general crossover point, which is more particularly specified by the detection in part 116, and which may further be calibrated by the confirmation in part 118. For example, the first user may identify the crossover point in part 114 as occurring at roughly time T1. The change-point detection technique may then detect the crossover point in part 116 as occurring at time T2. If time T2 is close to time T1, then the crossover point is set to time 12. The second user may then confirm the crossover point in part 118 as occurring at time T3. If time T3 is close to time T2, then the crossover point is set to time T3.

Referring next to FIG. 1B, a composite driver is derived from the first driver and the second driver, based on the revenue, and using a dynamic mixture model (120). The model is a mixture model in that it takes into account both the first driver and the second driver. The model is a dynamic model in that it takes into account that the first driver and the second driver have changing values over time. The dynamic mixture model is not to be confused with the model that is to be constructed for forecasting revenue based at least on the composite driver after derivation.

The composite driver may be constructed as follows. A first distance objective function between a composite driver and the revenue over the time points before the crossover point is specified (122). The first distance objective function may be a mean absolute deviation between two sets of values over a time series. Generally, the first distance objective function can be mathematically expressed as DOF1=f(a,b), where a is one set of values over the time series and b is another set of values over the time series.

It is noted that the revenue over the entire time series can be expressed as R=R1 . . . R2, where R1 is the revenue over the time series before the crossover point and R2 is the revenue over the time series after the crossover point. Likewise, the composite driver can be expressed as CD=CD1 . . . CD2 where CD1 is the composite driver over the time series before the crossover point and CD2 is the composite over the time series after the crossover point. The first driver can be expressed as D1=D11 . . . D12, where D11 is the first driver over the time series before the crossover point and D12 is the first driver over the time series after the crossover point. Similarly, the second driver can be expressed as D2=D21 . . . D22, where D21 is the second driver over the time series before the crossover point and D22 is the second driver over the time series after the crossover point.

As such, the first distance objective function can be more particularly mathematically expressed as DOF1=f(CD1,R1). Furthermore, the composite driver can be mathematically expressed as CD1=αD11+(1−α)D21, where α is a first weighting parameter for the time points before the crossover point. The first weighting parameter can be the same for each time point before the crossover point, or can differ for each time point before the crossover point. Thus, the first distance objective function is DOF1=f(αD11+(1−α)D21,R1).

The one or more first weighting parameters are selected to minimize the first distance objective function (124). A technique, such as calculating and comparing values of this objective function over a grid of a discrete set of parameter values, can be used to determine α such that DOF1=f(αD11+(1−α)D21,R1) is minimized over the time series before the crossover point. The result of parts 122 and 124 is the composite driver for time points before the crossover point. The composite driver for time points before the crossover point is specifically a truncated geometrically weighted average of the first driver and the second driver for the time points before the crossover point. The first weighting parameter, α, can be a regular or proportional weighting parameter that is constant over the time points before the crossover point. The first weighting parameter can alternatively be a geometric weighting parameter that can vary for each time point before the crossover point.

Similarly, a second distance objective function between a composite driver and the revenue over the time points after the crossover point is specified (126). The second distance objective function may also be a mean absolute deviation between two sets of values over a time series. Generally, as with the first distance objective function, the second distance objective function can be mathematically expressed as DOF2=f(a,b), where a is one set of values over the time series and b is another set of values over the time series.

As such, the second distance objective function can be more particularly mathematically expressed as DOF2=f(CD2,R2). Furthermore, the composite driver can be mathematically expressed as CD2=βD22+(1−β)D12, where β is a second weighting parameter for the time points after the crossover point. The second weighting parameter can be the same for each time point before the crossover point, or can differ for each time point before the crossover point. Thus, the second distance objective function is DOF2=f(βD22+(1−β)D12,R2).

The second weighting parameters are selected to minimize the second distance objective function (128). A technique, such as calculating and comparing values of this objective function over a grid of a discrete set of parameter values, can also be used to determine β such that DOF2=f(βD22+(1−β)D12,R2) is minimized over the time series after the crossover point. The result of parts 126 and 128 is the composite driver for time points after the crossover point. The composite driver for time points after the crossover point, similar to the composite driver for the time points before the crossover point, is specifically a truncated geometrically weighted average of the first driver and the second driver for the time points after the crossover point. The second weighting parameter, β, can be a regular or proportional weighting parameter that is constant over the time points after the crossover point. The second weighting parameter can alternatively be a geometric weighting parameter that can vary for each time point after the crossover point.

The result of parts 122, 124, 126, and 128 is a composite driver that has values αD11ₜ+(1−α)D21ₜ for each time point t before the crossover point, and that has values βD22ₜ+(1−β)D12ₜ for each time point t after the crossover point. Before the crossover point, the weighting parameter(s) α determines how values of the first driver and the second driver are combined to yield values of the composite driver. At the crossover point, the weighting parameter(s) β determines how values of the first driver and the second driver are combined to yield values of the composite driver.

FIG. 5 is a graph of example revenue, an example first driver, an example second driver, and a composite driver derived from the example first driver and the example second drivers using the example revenue. The graph of FIG. 5 is specifically the graph of FIG. 5 with an additional line 502. The line 502 corresponds to the composite driver. As in FIG. 5, the line 202A corresponds to the revenue, and the lines 202B and 202C correspond to the first driver and the second driver, respectively. The y-axis of FIG. 5 denotes normalized values, whereas the x-axis of FIG. 5 denotes a series of time points. Inspection of FIG. 5 demonstrates that the line 502 corresponding to the composite driver is more similar to the line 202A corresponding to the revenue than either the line 202B corresponding to the first driver or the line 202C corresponding to the second driver is.

Referring back to FIG. 16, a model for forecasting the revenue can be constructed, based at least on the composite driver in lieu of the first driver and the second driver (130). That is, rather than using the first and the second drivers directly in constructing the model, the composite driver is instead employed. A model for forecasting the revenue can be constructed as has been described in the PCT patent application entitled “causal dynamic model for revenue,” filed on Nov. 27, 2010, and assigned PCT patent application number PCT/US10158140 (attorney docket no. 201002023-1).

Thereafter, real-time forecasting of the revenue can be performed using the model constructed in part 130, based at least on the composite driver in lieu of the first driver and the second driver (132). That is, as before, rather than using the first and the second drivers directly in real-time forecasting of the revenue, the composite driver is instead employed. Specifically, as data for the first and the second drivers becomes available, the data for the composite driver is generated and input into the model for forecasting the revenue. The model for forecasting revenue constructed in part 130 and used in part 132 is not to be confused with the dynamic mixture model used to derive the composite driver in part 120.

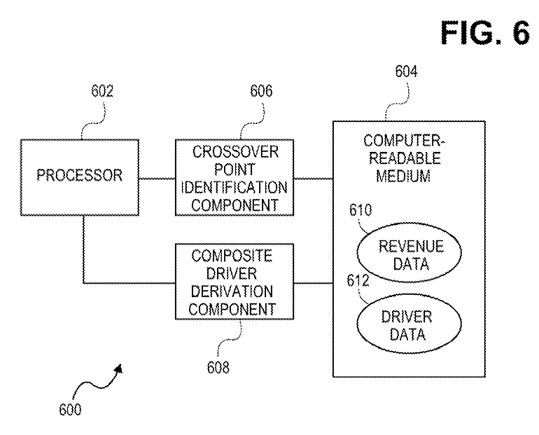

FIG. 6 shows a system 600, according to an example of the disclosure. The system 600 may be implemented as one or more computing devices, such as desktop computers and laptop computers. The system 600 includes a processor 602, a non-transitory computer-readable data storage medium 604, a crossover point identification component 606, and a composite driver generation component 608.

The computer-readable data storage medium 604 stores revenue data 610 and driver data 612. The revenue data 610 is normalized historical data of revenue for each of a number of time points. The driver data 612 is normalized historical data of each of a first driver and a second driver for each of a number of time points.

The components 606 and 608 can each be one or more computer programs that are executable by the processor 602. These computer programs may be stored on the computer-readable data storage medium 604, or another computer-readable data storage medium. The crossover point identification component 606 is to identify the crossover point based on the revenue data 610 and the driver data 612, in accordance with the method 100 of FIGS. 1A and 1B. The composite driver derivation component 608 is to derive a composite driver from the revenue data 610 and the driver data 612, also in accordance with the method 100.

1. A method comprising:
identifying a crossover point between a first driver and a second driver over a series of time points, each of the first driver and the second driver being a variable, each of the first driver and the second driver affecting or relating to revenue to be forecast; and,
deriving, by a processor, a composite driver from the first driver and the second driver, based on the revenue, and using a model having one or more first weighting parameters for the time points before the crossover point and one or more second weighting parameters for the time points after the crossover point,
wherein the crossover point is a time point within the series of time points at which the revenue transitions from being more influenced by the first driver than by the second driver to being more influenced by the second driver than by the first driver.

2. The method of claim 1, wherein identifying the crossover point between the first driver and the second driver comprises:
visually inspecting, by a user, the first driver and the second driver over the series of time points to identify the crossover point.

3. The method of claim 1, wherein identifying the crossover point between the first driver and the second driver further comprises:
detecting the crossover point between the first driver and the second driver, by a processor.

4. The method of claim 3, wherein detecting the crossover point between the first driver and the second driver, by the processor, comprises:
applying a change-point detection technique, by the processor, to detect the crossover point between the first driver and the second driver.

5. The method of claim 4, wherein the change-point detection technique is cumulative sum change-point detection technique.

6. The method of claim 3, wherein the user is a first user, and identifying the crossover point between the first driver and the second driver further comprises:
confirming, by a second user, the crossover point identified by visual inspection by the first user and the crossover point detected by the processor.

7. The method of claim 1, wherein deriving the composite driver from the first driver and the second driver using the model comprises:
specifying a first distance objective function between the composite driver and the revenue over the series of time points before the crossover point, the first distance objective function having the one or more first weighting parameters, the one or more first weighting parameters controlling a weight of each of the first driver and the second driver within the composite driver over the series of time points before the crossover point;
selecting the one or more first weighting parameters to minimize the first distance objective function over the series of time points before the crossover point;
specifying a second distance objective function between the composite driver and the revenue over the series of time points after the crossover point, the second distance objective function having the one or more second weighting parameters, the one or more second weighting parameters controlling the weight of each of the first driver and the second driver within the composite driver over the series of nine points after the crossover point; and,
selecting the one or more second weighting parameters to minimize the second distance objective function over the series of time points after the crossover point.

8. The method of claim 7, wherein for each time point before the crossover point, the composite driver is equal to a value of the first driver at the time point multiplied by one of the one or more first weighting parameters, plus a value of the second driver at the time point multiplied by one minus the one of the one or more first weighting parameters,
and wherein for each time point after the crossover point, the composite driver is equal to a value of the second driver at the time point multiplied by one of the one or more second weighting parameters, plus a value of the first driver at the time point multiplied by one minus the one of the one or more second weighting parameters.

9. The method of claim 7, wherein each of the first distance objective function and the second distance objective function between the composite driver and the revenue determines a mean absolute deviation between composite driver and the revenue.

10. The method of claim 1, further comprising, prior to identifying the crossover point between the first driver and the second driver:
normalizing the first driver, the second driver, and the revenue, by the processor.

11. The method of claim 10, wherein normalizing the first driver comprises:
determining a minimum value of the first driver over the series of time points;
determining a maximum value of the first driver over the series of time points;
for as value of the first driver at each time point,
dividing, the value by the minimum value to determine a first quotient;
dividing the first quotient by a difference between the maximum value and the minimum value to determine a second quotient, the second quotient being a normalized value for the first driver at the time point.

12. A non-transitory computer-readable data storage medium to store a computer program, execution of the computer program by a processor causing a method to be performed, the method comprising:
performing real-time forecasting of revenue, based on at least as composite driver that affects or relates to revenue,
wherein the composite driver is constructed by:
identifying a crossover point between a first driver and as second driver over a series of time points, each of the first driver and the second driver being a variable, each of the first driver and the second driver affecting or relating to the revenue; and,
deriving the composite driver from the first driver and the second driver, based on the revenue, and using a model having one or more first weighting parameters for the time points before the crossover point and one or more second weighting parameters for the time points after the crossover point,
wherein the crossover point is a time point within the series of time points at which the revenue transitions from being more influenced by the first driver than by the second driver to being more influence by the second driver than by the first driver.

13. The non-transitory computer-readable data storage medium of claim 12, wherein identifying the crossover point between the first driver and the second driver comprises:
visually inspecting, by a first user, the first driver and the second driver over the series of time points to identify the crossover point;
detecting the crossover point between the first driver and the second driver, using a change-point detection technique; and,
Confirming, by a second user, the crossover point identified by visual inspection by the first user and the crossover point detected using the change-point detection technique.

14. The non-transitory computer-readable data storage medium of claim 12, wherein deriving the composite driver from the first driver and the second driver using the model comprises;
specifying a first distance objective function between the composite driver and the revenue over the series of time points before the crossover point, the first distance objective function having the one or more first weighting parameters, the one or more first weighting parameters controlling a weight of each of the first driver and the second driver within the composite driver over the series of time points before the crossover point;
selecting the one or more first weighting parameters to minimize the first distance objective function over the series of time points before the crossover point;
specifying a second distance objective function between the composite driver and the revenue over the series of time points after the crossover point, the second distance objective function having the one or more second weighting parameters, the one or more second weighting parameters controlling the weight of each of the first driver and the second driver within the composite driver over the series of time points after the crossover point; and,
selecting the one or more second weighting parameters to minimize the second distance objective function over the series of time points after the crossover point,
wherein for each time point before the crossover point, the composite driver is equal to a value of the first driver at the time point multiplied by one of the one or more first weighting parameters, plus a value of the second driver at the time point multiplied by one minus the one of the one or more first weighting parameters,
and wherein for each time point after the crossover point, the composite driver is equal to a value of the second driver at the time point multiplied by one of the one or more second weighting parameters, plus a value of the first driver at the time point multiplied by one minus the one of the one or more second weighting parameters.

15. A system comprising:
a processor;
a computer-readable data storage medium to store revenue over a series of time points, and a value of each of a first driver and a second driver for each time point; and,
a composite driver derivation component executable by the processor to derive a composite driver from the first driver and the second driver, based on the revenue, using a model having one or more first weighting parameters for the time points before a crossover point and one or more second weighting parameters for the point the crossover point,
wherein the crossover point is a time point within the series of time points at which the revenue transitions from being more influenced by the first driver than by the second driver to being more influenced by the second driver than by the first driver.
